(19) United States
(12) Patent Application Publication
(10) Pub. No.: US 2025/0334359 A1
(43) Pub. Date: Oct. 30, 2025

(54) NOVEL DAYTIME PASSIVE RADIATIVE COOLING CERAMIC WITH SELF-CLEANING PROPERTIES AND ITS MANUFACTURING PROCESS

(71) Applicant: Zhengzhou University, Zhengzhou (CN)

(72) Inventors: Xupei YAO, Zhengzhou (CN); Mingrui DU, Zhengzhou (CN); Hongyuan FANG, Zhengzhou (CN); Yanhui PAN, Zhengzhou (CN); Peng ZHAO, Zhengzhou (CN); Xueming DU, Zhengzhou (CN); Bin LI, Zhengzhou (CN); Kejie ZHAI, Zhengzhou (CN)

(21) Appl. No.: 18/771,879

(22) Filed: Jul. 12, 2024

(30) Foreign Application Priority Data
Apr. 29, 2024 (CN) 2024105313754

(51) Int. Cl. F28F 13/18; C04B 38/00; C04B 38/06; F28F 21/04

(52) U.S. Cl. CPC F28F 13/18; C04B 38/0061; C04B 38/0074; C04B 38/067; F28F 21/04; C04B 2235/32; C04B 2235/528; C04B 2235/5436; C04B 2235/6023; C04B 2235/606; C04B 2235/9607

(57) ABSTRACT

This invention pertains to the field of refrigeration materials, unveiling a novel ceramic designed for daytime passive radiative cooling endowed with a self-cleaning capability, along with its preparation method. The architectural design of this cooling ceramic incorporates a base layer composed of a porous composite ceramic, characterized by its intricate structure of closed pores arranged according to a varied grading of sizes, potentially enhanced with an additional protective layer. The method of preparation involves integrating a polymer solution with metal oxides and micron-sized hollow glass microspheres to craft a malleable slurry. This slurry is then shaped within a mold, compacted under pressure to form a preliminary structure, which is subsequently dried and sintered, culminating in the production of a porous composite ceramic specifically engineered for radiative cooling.

### TECHNICAL FIELD

The invention pertains to the technological domain of refrigeration materials and specifically introduces an innovative daytime passive radiative cooling ceramic that process self-cleaning properties, alongside the methodology for its manufacture.

### BACKGROUND

According to current data, an estimated 10% of the world's energy consumption is allocated to cooling systems within buildings. Anticipating a rapid rise in energy demand due to ongoing population growth, industrialization, and lifestyle enhancements, it is projected that by mid-21st century energy usage for refrigeration purposes could escalate over tenfold, potentially intensifying the existing energy dilemma and contributing to global warming. Hence, it's imperative to innovate refrigeration solutions that conserve energy and safeguard the environment.

Daytime radiative cooling materials are innovative cooling substances that consume zero energy. These materials can reflect up to more than 90% of solar light with their unique surface configurations, inhibiting heat absorption from solar radiation. Concurrently, they're capable of transmitting their internal heat to the frigid vastness of outer space (3K), by harnessing the atmospheric transparency window (8-13 μm), manifesting as long-wave infrared radiation. This process lowers the material's temperature and facilitates cooling. Addressing the need for varying application contexts, the development has shifted toward radiative cooling ceramics that are more resilient, durable, and environmentally stable. Due to their high porosity aimed to increase sunlight reflectivity and long-wave infrared emissivity, these ceramics might exhibit compromised mechanical strength. Moreover, their predominantly open-pore structure makes them susceptible to contamination by dust and other pollutants, which can degrade their cooling efficiency.

### Innovation Overview

To tackle the existing technical limitations, this invention introduces a self-cleaning daytime passive radiative cooling ceramic along with its manufacturing process. This innovation effectively enhances the mechanical strength, rendering the material more efficient for cooling and highly pollution-resistant, addressing the challenges stipulated in the preceding background technology.

To fulfill these objectives, the following technological proposal is provided: a daytime passive radiative cooling ceramic with self-cleaning capability. The said ceramic consists of a base layer composed of a porous composite ceramic material. The porosity of the base layer is attributed to closed pores of varied diameters, which effectively prevent the infiltration of dust and other pollutants. The base layer possesses self-cleaning properties and has relatively high mechanical strength. It is designed to selectively emit long-wave infrared while ensuring high reflectance of sunlight, delivering excellent radiative cooling results.

Preferably, the porosity of the base layer ranges between 50%-90%; its sunlight reflectance is no less than 90%; its long-wave infrared emissivity is also no less than 90%; its flexural strength is no less than 25 MPa, and its compressive strength no less than 60 MPa.

To further achieve the stated objective, this invention includes an additional technical strategy: a daytime passive radiative cooling ceramic with self-cleaning functionality, which also incorporates a protective layer. This layer, made of a transparent, dense, and hydrophobic glass material, is placed on the side of the base layer away from the surface to be cooled. Having a thickness of 5 μm-20 μm, this protective layer provides a hydrophobic self-cleaning feature and further prevents pollutant intrusion.

On the other hand, in pursuit of the stated goals, this invention provides an innovative method for preparing a daytime passive radiative cooling ceramic featuring self-cleaning capabilities, embodied through the steps below:
S1: Formulating a slurry by mixing a polymer solution with metal oxides and micron-sized hollow glass microspheres;
S2: Transferring the slurry into a designated mold;
S3: Applying controlled pressure to the mold content to shape a green body;
S4: Drying the formed body;
S5: Proceeding to sinter the now-dried green body, achieving a porous composite ceramic endowed with efficient radiative cooling capability.

Preferably, the method is characterized by a selection of micron-sized hollow glass microspheres with diameters ranging from 2 μm to 50 μm and a diverse array of metal oxides including powdery Al₂O₃, TiO₂, MgO, CaCO₃, ZnO, and ZrO₂ with an optimal mass ratio of the microspheres to metal oxides set between 0.2 and 1. The polymer solution may be one or a combination of options such as polyvinylidene fluoride, polydimethylsiloxane, polymethyl methacrylate, or polyvinyl alcohol solutions.

Preferably, the method outlined is characterized by the compression molding of the ceramic mix in the die. This is achieved by uniformly applying pressure between 2 MPa and 15 MPa using a press, which is maintained for at least 30 minutes to ensure the expulsion of air bubbles from the slurry, resulting in the formulation of a compact green body. Preferably, the drying and subsequent sintering of the green body as prescribed lead to the production of a porous composite ceramic with radiative cooling capabilities. The dried body is subjected to a temperature ramp up in the sintering chamber, starting from room temperature and gradually increasing to 400-600° C. at a rate of 2-4° C. per minute, holding at this range for 2-4 hours. The temperature then escalates to 800-1200° C. at the same rate and is maintained for an additional 3-6 hours. Afterwards, the ceramic is naturally cooled back to room temperature, with an airflow set between 100-300 ml per minute to aid in the process.

Additionally, to achieve the above objectives, a complementary method is proposed to accomplish the goals, involving the preparation method for a self-cleaning, daytime passive radiative cooling ceramic, which includes:
S6: Formulating a slurry by mixing a polymer solution with metal oxides and micron-sized hollow glass microspheres;
S7: Transferring the slurry into a designated mold;
S8: Applying controlled pressure to the mold content to shape a green body;
S9: Drying the formed body;
S10: Proceeding to sinter the now-dried green body, achieving a porous composite ceramic endowed with efficient radiative cooling capability;
S11: Incorporating micron-sized silica particles into polymer solution to form a casting solution;
S12: Applying the solution as a coating to the sintered porous composite ceramic with radiative cooling features;
S13: Final sintering of the coated ceramic ensures it is equipped with a protective layer, instrumental in the passive radiative cooling function.

Preferably, the procedural details of S11 include:
S11.1: Drying the micron-sized silica particles;
S11.2: Introducing these particles into a polymer solution;
S11.3: Stirring the polymer solution with the micron-sized silica particles to obtain the casting solution.

Preferably, the criteria for selecting the micron-sized silica particles as mentioned hinge on their sizes, which should fall within a range from 2 μm to 15 μm, optionally combining multiple sizes within this spectrum to achieve the desired particle profile.

The beneficial effects of the invention are: 1) This innovative creation leverages a strategic assortment of hollow glass microspheres to fabricate a composite ceramic beneath the protective coating, crafted to possess a multi-tiered pore architecture. This sophisticated design not only optimizes the distribution of pore sizes but also simultaneously achieves exceptional daytime radiative cooling efficiency and remarkable mechanical robustness. 2) The innovation extends to imbuing the self-cleaning daytime passive radiative cooling ceramic with a protective layer. This layer, made of a transparent, dense, and hydrophobic glass material, provides a self-cleaning feature, and further prevents pollutant intrusion. 3) The porous composite ceramic of this invention predominantly features closed pores, which serve as a steadfast barrier against pollutants such as dust infiltrating the material's core, thus ensuring sustained radiative cooling performance, even in the face of compromised protective coatings.

### BRIEF DESCRIPTION OF DRAWINGS

FIG. 1 depicts the structural design of a self-cleaning daytime passive radiative cooling ceramic according to Embodiment 1 of the present invention;

FIG. 2 depicts the structural design of a self-cleaning daytime passive radiative cooling ceramic according to Embodiment 2 of the present invention;

FIG. 3 is a flowchart of the method for preparing a self-cleaning daytime passive radiative cooling ceramic according to Embodiment 3 of the present invention;

FIG. 4 is a flowchart of Step S1 in Embodiment 3 of the present invention;

FIG. 5 is a flowchart of the method for preparing a self-cleaning daytime passive radiative cooling ceramic according to Embodiment 4 of the present invention;

FIG. 6 is a flowchart of Step S11 in Embodiment 4 of the present invention.

### DETAILED DESCRIPTION

The following will describe the technical solutions in the embodiments of this invention clearly and completely based on the drawings. The described embodiments are clearly only a part of the invention's possible applications. All other embodiments obtained by those skilled in the art based on the embodiments of this invention, without making creative work, fall within the protection scope of this invention.

### Embodiment 1

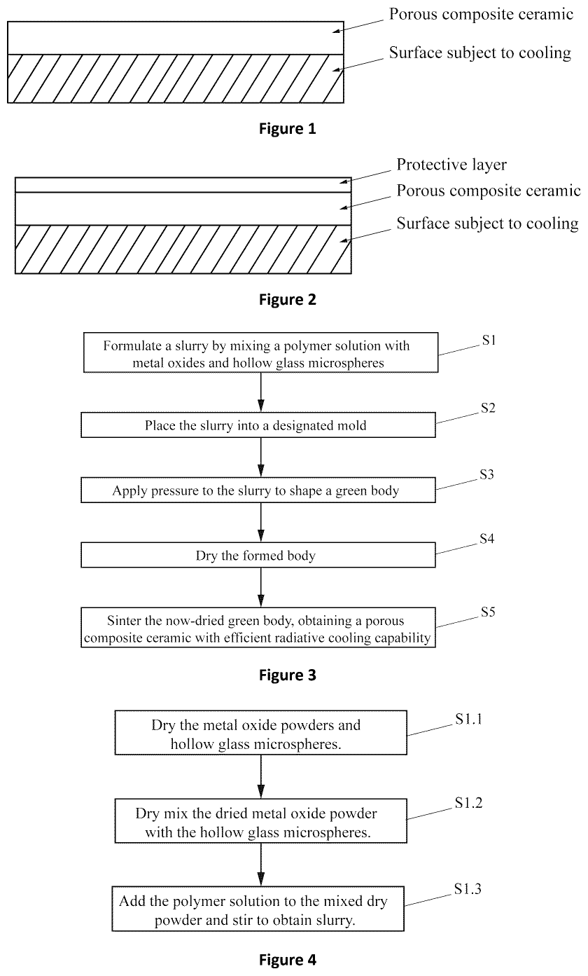

Refer to FIG. 1 for a structural schematic showcasing a self-cleaning passive daytime radiative cooling ceramic developed in this invention. The architectural design of this cooling ceramic incorporates a base layer composed of a porous composite ceramic, characterized by its intricate structure of closed pores arranged according to a varied grading of sizes, potentially enhanced with an additional protective layer which further prevents pollutant intrusion. This layer is placed on the side subject to cooling, which can be wood, concrete, tiles, glass, metal, and plastic; or on the surface of structures to be cooled, such as a building, automobile, train, ship, road, oil tank, or pipeline.

Additionally, the metal oxides used in this layer can include one or several of the following: Al₂O₃, TiO₂, MgO, CaCO₃, ZnO, and ZrO₂

Additionally, micron-sized hollow glass microspheres are chosen from diameters between 2 μm and 50 μm.

Additionally, micron-sized hollow glass microspheres along with the metal oxides, are blended at a specific weight ratio ranging from 0.2 to 1.

Additionally, the porosity of the base layer is 50%-80%.

### Embodiment 2

As depicted in FIG. 2, this embodiment of the self-cleaning passive daytime radiative cooling ceramic expands on the first by adding a protective layer atop the base layer. The base layer rests upon the cooling surface, which reflects the ultraviolet, visible, and near-infrared components of sunlight while selectively emitting long-wave infrared. The protective layer, a dense transparent hydrophobic glass with a thickness between 5 μm and 20 μm, is placed on the side of base layer opposite the surface to be cooled and complements the ceramic's structure by offering self-cleaning properties and additional dust and pollutant defense.

Below, the preparing processes for these daytime passive radiative ceramics with self-cleaning capabilities as per the first and second embodiments will be outlined subsequently.

### Embodiment 3

As illustrated in FIG. 3, this figure details a flowchart of the preparation method for the self-cleaning daytime passive radiative cooling ceramics disclosed in this invention. The preparation process involves the following steps:

S1: Formulating a slurry by mixing a polymer solution with metal oxides and micron-sized hollow glass microspheres;

Wherein, the metal oxide powder that forms the base layer could be any one or a combination of the following: Al₂O₃, TiO₂, MgO, CaCO₃, ZnO, and ZrO₂.

Wherein, the micron-sized hollow glass microbeads are selected with particle diameters ranging from 2 μm to 50 μm.

Wherein, the weight ratio of these microbeads to the metal oxide powders is kept from 0.25 to 1.

Wherein, the polymer solution may be one or a combination of options including polyvinylidene fluoride (PVDF), polydimethylsiloxane (PDMS), polymethyl methacrylate (PMMA), or polyvinyl alcohol (PVA) solutions. Optionally, in one embodiment, a 3% PVA polymer solution is utilized.

Additionally, depicted in FIG. 4, the preparation of the slurry in Step S1 includes specific procedures:

S1.1: Drying the metal oxide powders and micron-sized hollow glass microbeads.

Specifically, drying the in an oven for a period based on the requirements, such as 12 hours, to eliminate any moisture.

S1.2: Mixing the dried metal oxide powder with the micron-sized hollow glass microbeads.

Specifically, mixing the dry micron-sized hollow glass microbeads with the metal oxide powder at a mass ratio between 0.25 to 1, using a magnetic stirrer to stir the two types of dry powder for 5-10 minutes to allow for complete and uniform mixing.

S1.3: Adding the polymer solution to the mixed dry powder and stirring to obtain slurry. Specifically, during the stirring process, adding the 3% PVA solution to the dry powder in 3-5 portions within 3-5 minutes, with the mass ratio of polymer solution to dry powder set between 0.2 to 1, continuing to stir for another 5-10 minutes after adding until the powder is evenly dispersed without observable aggregation to obtain a uniform slurry. S2: Transferring the slurry into a designated mold.

Understandably, the slurry is placed into a mold of a chosen shape, aligned with the desired form of the cooling ceramic.

S3: Applying controlled pressure to the mold content to shape a green body.

Specifically, this mold is subjected to a uniform pressure using a press, spanning a range from 2 MPa to 15 MPa, for longer than 30 minutes. This step is crucial for degassing and shaping the green body prior to drying.

S4: Drying the formed body.

Specifically, the green body is then dried for a period based on requirements, for example, at room temperature for 24 hours.

Optionally, in one embodiment, the dried green body can be further shaped as needed after drying.

S5: Proceeding to sinter the now-dried green body, achieving a porous composite ceramic endowed with efficient radiative cooling capability.

The sintering process can be carried out in a furnace. In one optional embodiment, step S5 can specifically be as follows: the dried body is subjected to a temperature ramp up in the sintering chamber, starting from room temperature and gradually increasing to 400-600° C. at a rate of 2-4° C. per minute, holding at this range for 2-4 hours. The temperature then escalates to 800-1200° C. at the same rate and is maintained for an additional 3-6 hours. Afterwards, the ceramic is naturally cooled back to room temperature, with an airflow set between 100-300 ml per minute to aid in the process.

Understandably, the self-cleaning daytime passive radiative cooling ceramics of this embodiment are placed on the surface subject to cooling, which can be wood, concrete, tiles, glass, metal, and plastic, or on the surface of structures subject to cooling, such as a building, automobile, train, ship, road, oil tank, or pipeline. The self-cleaning daytime passive radiative cooling ceramics of the invention can be used on the surface of any article to cool it down and maintain a stable temperature.

Optionally, in other embodiments, the self-cleaning daytime passive radiative cooling ceramics can be set on surfaces of other media materials, using the aforementioned process, prior to their application onto the surfaces requiring temperature control such as a building, automobile, train, ship, road, oil tank, or pipeline.

### Embodiment 4

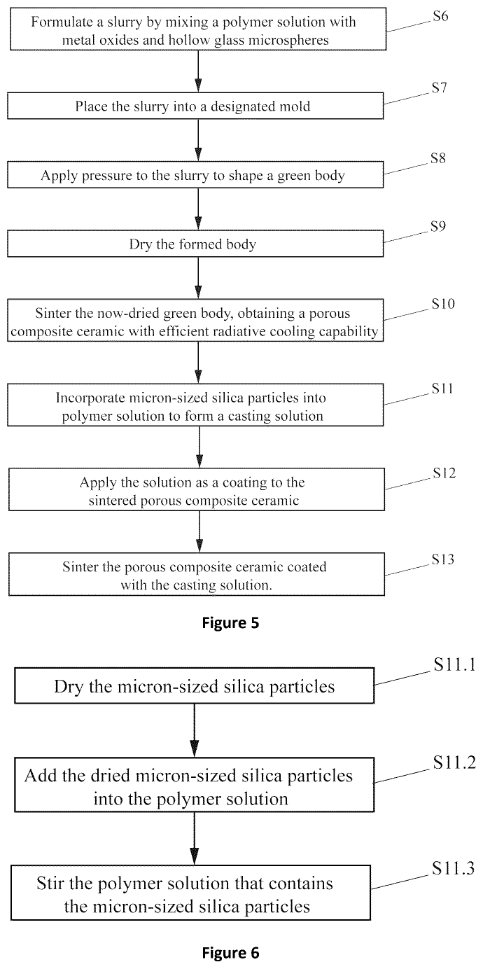

FIG. 5 is a flowchart depicting the method for preparing self-cleaning daytime passive radiative cooling ceramics with protective layers, as provided by this invention. The method includes the following steps:

S6: Formulating a slurry by mixing a polymer solution with metal oxides and micron-sized hollow glass microspheres.

S7: Transferring the slurry into a designated mold.

S8: Applying controlled pressure to the mold content to shape a green body.

S9: Drying the formed body.

S10: Proceeding to sinter the now-dried green body, achieving a porous composite ceramic endowed with efficient radiative cooling capability.

It can be understood that the above steps S6-S10 are similar to S1-S5 in the first embodiment and are not repeated here.

S11: Incorporating micron-sized silica particles into polymer solution to form a casting solution.

Wherein, the casting solution is formed by dissolving a polymer in an organic solvent.

The polymer solution may be one or a combination of options including polyvinylidene fluoride (PVDF), polydimethylsiloxane (PDMS), polymethyl methacrylate (PMMA), or polyvinyl alcohol (PVA) solutions. Optionally, in one embodiment, a 3% PVA polymer solution is utilized.

In an optional embodiment, FIG. 6 is a flowchart for step S11 described in FIG. 5, where step S11 specifically includes:

S11.1: Drying the micron-sized silica particles.

Wherein, the micron-sized silica particles are selected with particle diameters ranging from 2 μm to 50 μm.

Specifically, drying the in an oven for a period based on the requirements, such as 12 hours, to eliminate any moisture.

S11.2: Mixing the dried micron-sized silica particles into the polymer solution. Optionally, mixing the dried silica particles into a 3% PVA solution.

S11.3: Stir the polymer solution containing the micron-sized silica particles.

Specifically, stir the solution until the silica particles are evenly dispersed without observable agglomeration. Then, by stirring slowly, remove air bubbles to degas the suspension and obtain the casting solution.

S12: Applying the solution as a coating to the sintered porous composite ceramic with radiative cooling features.

S13: Sinter the porous composite ceramic coated with the casting solution.

The coated ceramic is placed into a furnace for sintering. The temperature ramps up in the sintering chamber, starting from room temperature and gradually increasing to 400-600° C. at a rate of 2-4° C. per minute, holding at this range for 2-4 hours. The temperature then escalates to 800-1200° C. at the same rate and is maintained for an additional 3-6 hours. Afterwards, the ceramic is naturally cooled back to room temperature, with an airflow set between 100-300 ml per minute to aid in the process.

Although the present invention has been described in detail with reference to the embodiment, technical experts of this field can still make modifications to the technical solutions recorded in the aforementioned embodiment or perform equivalent substitutions for some technical features thereof. Any modifications, equivalent substitutions, and improvements that are made within the spirit and principles of this invention should be included within the protection scope of this invention.

What is claimed is:

1. An innovative daytime passive radiative cooling ceramic featuring self-cleaning properties, which comprises a base layer of porous composite ceramic, The distinct composition of the base layer incorporates closed pores organized in a multi-sized grading to create an effective pore structure.

2. In relation to the ceramic defined in claim 1, it is characterized by a base layer porosity between 50%-90%, ensuring excellent solar reflectivity of no less than 90% and long-wave infrared emissivity also not less than 90%, Furthermore, the base layer exhibits mechanical robustness with a bending strength of at least 25 MPa and a compressive strength of no less than 60 MPa.

3. For the ceramic described in claim 1, it uniquely integrates a protective layer made of a transparent, dense, and hydrophobic glass material, This layer is strategically placed on the side opposite to that which is subject to cooling, with its thickness optimized between 5 μm and 20 μm.

4. The method of fabricating the above ceramic with self-cleaning attributes, as outlined in claim 1, is distinctive for its meticulous process, It involves:
S1: Formulating a slurry by mixing a polymer solution with metal oxides and hollow glass microspheres;
S2: Transferring the slurry into a designated mold;
S3: Applying controlled pressure to the mold content to shape a green body;
S4: Drying the formed body;
S5: Proceeding to sinter the now-dried green body, achieving a porous composite ceramic endowed with efficient radiative cooling capability.

5. Delving into the technical specifics of the preparation method detailed in claim 4, the method is characterized by a selection of micron-sized hollow glass microspheres with diameters ranging from 2 μm to 50 μm and a diverse array of metal oxides including powdery Al₂O₃, TiO₂, MgO, CaCO₃, ZnO, and ZrO₂ with an optimal mass ratio of the microspheres to metal oxides set between 0.2 and 1, The polymer solution may be one or a combination of options such as polyvinylidene fluoride, polydimethylsiloxane, polymethyl methacrylate, or polyvinyl alcohol solutions.

6. The method outlined in claim 4 is characterized by the compression molding of the ceramic mix in the die, This is achieved by uniformly applying pressure between 2 MPa and 15 MPa using a press, which is maintained for at least 30 minutes to ensure the expulsion of air bubbles from the slurry, resulting in the formulation of a compact green body.

7. The drying and subsequent sintering of the green body as prescribed in claim 4 lead to the production of a porous composite ceramic with radiative cooling capabilities, The dried body is subjected to a temperature ramp up in the sintering chamber, starting from room temperature and gradually increasing to 400-600° C. at a rate of 2-4° C. per minute, holding at this range for 2-4 hours, The temperature then escalates to 800-1200° C. at the same rate and is maintained for an additional 3-6 hours, Afterwards, the ceramic is naturally cooled back to room temperature, with an airflow set between 100-300 ml per minute to aid in the process.

8. The preparation method for a self-cleaning, daytime passive radiative cooling ceramic as described in claim 3 includes several steps:
S6: Formulating a slurry by mixing a polymer solution with metal oxides and micron-sized hollow glass microspheres;
S7: Transferring the slurry into a designated mold;
S8: Applying controlled pressure to the mold content to shape a green body;
S9: Drying the formed body;
S10: Proceeding to sinter the now-dried green body, achieving a porous composite ceramic endowed with efficient radiative cooling capability;
S11: Incorporating micron-sized silica particles into polymer solution to form a casting solution;
S12: Applying the solution as a coating to the sintered porous composite ceramic with radiative cooling features;
S13: Final sintering of the coated ceramic ensures it is equipped with a protective layer, instrumental in the passive radiative cooling function.

9. The method of claim 8, wherein the incorporating micron-sized silica particles into polymer solution to form a casting solution further comprises:
S11.1: Drying the micron-sized silica particles;
S11.2: Introducing these particles into a polymer solution;
S11.3: Stirring the polymer solution with the micron-sized silica particles to obtain the casting solution.

10. The criteria for selecting the micrometer-scale silica particles as mentioned in claim 9 hinge on their sizes, which should fall within a range from 2 μm to 15 μm, optionally combining multiple sizes within this spectrum to achieve the desired particle profile.
